(19) United States
(12) Patent Application Publication
(10) Pub. No.: US 2015/0368428 A1
(43) Pub. Date: Dec. 24, 2015

(54) Use of a polycarboxylic acid in the production of an elastomer composition

(71) Applicant: RHODIA OPERATIONS, Paris (FR)

(72) Inventors: Laurent GUY, Rillieux La Pape (FR); Cedric BOIVIN, Neuville sur Saone (FR); Soline DE CAYEUX, Lyon (FR); Philippe JOST, Serpaize (FR)

(21) Appl. No.: 14/766,483

(22) PCT Filed: Feb. 14, 2014
(86) PCT No.: PCT/EP2014/052916

§ 371 Date: Aug. 7, 2015

(30) Foreign Application Priority Data
Feb. 14, 2013 (FR) 1300319

(51) Int. Cl. C08K 5/092; C08K 3/36; C08L 9/06

(52) U.S. Cl. CPC C08K 5/092; C08L 9/06; C08K 3/36; C08L 2205/02; C08L 2205/06

(57) ABSTRACT

The invention relates to the use of a polycarboxylic acid in the preparation of an elastomer composition comprising a precipitated silica as reinforcing inorganic filler and an elastomer, in which said polycarboxylic acid and said precipitated silica are incorporated, independently of each other, into an elastomer.

The invention also relates to elastomer compositions and to a process for preparing the same.

The present invention relates to the use of polycarboxylic acid(s) in elastomer compositions comprising at least one elastomer and a precipitated silica as reinforcing inorganic filler.

The invention also relates to the corresponding elastomer compositions and to articles, in particular tires, comprising such compositions.

The aim of the present invention is especially to propose the use of a particular additive in elastomer compositions comprising a reinforcing filler, which advantageously affords a reduction in the viscosity of these elastomer compositions, thus facilitating their use.

The present invention first proposes the use of polycarboxylic acid(s) in the preparation of elastomer compositions comprising at least one elastomer and a precipitated silica as reinforcing inorganic filler.

One of the subjects of the invention is the use of at least one polycarboxylic acid in an elastomer composition comprising at least one elastomer and a precipitated silica as reinforcing inorganic filler.

According to the invention, the precipitated silica and the polycarboxylic acid(s) are added, independently of each other (optionally at the same time), to the elastomer(s).

In other words, according to the invention, a precipitated silica and one or more polycarboxylic acids not contained in/on said silica are added to the elastomer(s).

The invention amounts to using in the preparation of an elastomer composition, comprising at least one elastomer and a precipitated silica as reinforcing inorganic filler, at least one polycarboxylic acid, said precipitated silica and said polycarboxylic acid being incorporated, independently of each other, into at least one elastomer.

The invention also relates to a process for preparing an elastomer composition, in which a precipitated silica as reinforcing inorganic filler and at least one polycarboxylic acid are incorporated, independently of each other, into at least one elastomer.

Advantageously, the invention relates to the use of at least one polycarboxylic acid in an elastomer composition comprising at least one elastomer and a precipitated silica as reinforcing inorganic filler, for reducing the viscosity of said composition.

According to the invention, the term “polycarboxylic acid” means polycarboxylic acids comprising at least two carboxylic acid functional groups. The term “carboxylic acid functional group” is taken herein in its usual meaning and refers to the —COOH functional group.

The polycarboxylic acid used according to the invention may contain two, three, four or more than four carboxylic acid functional groups.

The polycarboxylic acid used according to the invention may be a saturated or unsaturated polycarboxylic acid. In one preferred embodiment, the polycarboxylic acid used is a saturated polycarboxylic acid.

According to the invention, the polycarboxylic acid is preferably chosen from dicarboxylic and tricarboxylic acids.

According to the invention, the polycarboxylic acid used may be a linear or branched, saturated or unsaturated, preferably saturated, aliphatic polycarboxylic acid containing from 2 to 20 carbon atoms or an aromatic polycarboxylic acid containing from 7 to 20 carbon atoms. The carboxylic acid may optionally comprise hydroxyl groups and/or halogen atoms. The aliphatic polycarboxylic acid may optionally comprise heteroatoms on the main chain, for example N or S. Generally, the polycarboxylic acid used according to the invention is chosen from the group consisting of linear or branched, saturated or unsaturated, preferably saturated, aliphatic polycarboxylic acids and aromatic polycarboxylic acids containing from 2 to 16 carbon atoms.

Thus, advantageously, the polycarboxylic acid used according to the invention is chosen from the group consisting of saturated, linear or branched aliphatic polycarboxylic acids containing from 2 to 16 carbon atoms.

Among the aliphatic polycarboxylic acids, mention may be made of linear, saturated or unsaturated, preferably saturated, polycarboxylic acids containing from 2 to 14 carbon atoms, and preferably from 2 to 12 carbon atoms. The polycarboxylic acid used may contain 2, 3, 4, 5, 6, 7, 8, 9, 10, 11 or 12 carbon atoms. Advantageously, the polycarboxylic acid used may contain 4, 5, 6, 7, 8, 9 or 10 carbon atoms, and preferably 4, 5, 6, 7 or 8 carbon atoms. For example, the polycarboxylic acid used may contain 4, 5 or 6 carbon atoms.

In particular, non-limiting examples that may be mentioned of linear aliphatic polycarboxylic acids used in the invention include acids chosen from the group consisting of oxalic acid, malonic acid, tricarballylic acid, succinic acid, glutaric acid, adipic acid, pimelic acid, suberic acid, azelaic acid and sebacic acid.

Among the branched polycarboxylic acids, mention may be made of methylsuccinic acid, ethylsuccinic acid, oxalosuccinic acid, methyladipic acid, methylglutaric acid and dimethylglutaric acid. The term “methylglutaric acid” means both 2-methylglutaric acid and 3-methylglutaric acid and also the mixture of these two isomers in all proportions. The term “2-methylglutaric acid” is used to indicate both the (S) and (R) forms of the compound and the racemic mixture.

Among the unsaturated polycarboxylic acids, mention may be made of maleic acid, fumaric acid, itaconic acid, muconic acid, aconitic acid, traumatic acid and glutaconic acid.

Among the polycarboxylic acids comprising hydroxyl groups, mention may be made of malic acid, citric acid, isocitric acid and tartaric acid.

Among the aromatic polycarboxylic acids, mention may be made of phthalic acids, namely phthalic acid, orthophthalic acid, isophthalic acid, trimesic acid and trimellitic acid.

Preferably, the polycarboxylic acid used according to the invention is chosen from the group consisting of oxalic acid, malonic acid, tricarballylic acid, succinic acid, glutaric acid, adipic acid, pimelic acid, suberic acid, azelaic acid, sebacic acid, methylsuccinic acid, ethylsuccinic acid, methyladipic acid, methylglutaric acid, dimethylglutaric acid, malic acid, citric acid, isocitric acid and tartaric acid.

Preferably, the dicarboxylic and tricarboxylic acids are chosen from adipic acid, succinic acid, ethylsuccinic acid, glutaric acid, methylglutaric acid, oxalic acid and citric acid.

The polycarboxylic acid may also be chosen from the group consisting of oxalic acid, malonic acid, tricarballylic acid, succinic acid, glutaric acid, adipic acid, pimelic acid, suberic acid, azelaic acid, sebacic acid, methylsuccinic acid, ethylsuccinic acid, methyladipic acid, methylglutaric acid, dimethylglutaric acid, malic acid, citric acid, isocitric acid and tartaric acid. Preferably, the polycarboxylic acid may be chosen from the group consisting of oxalic acid, malonic acid, succinic acid, glutaric acid, adipic acid, pimelic acid, suberic acid, azelaic acid, sebacic acid, methylsuccinic acid, ethylsuccinic acid, methyladipic acid, methylglutaric acid, dimethylglutaric acid, malic acid, citric acid, isocitric acid and tartaric acid. Very preferably, the polycarboxylic acids may be chosen from the group consisting of succinic acid, glutaric acid, adipic acid, pimelic acid, suberic acid, azelaic acid, sebacic acid, methylsuccinic acid, ethylsuccinic acid, methyladipic acid, methylglutaric acid, dimethylglutaric acid, malic acid, citric acid and tartaric acid.

In a first variant of the invention, only one polycarboxylic acid is used in the elastomer composition.

Preferably, the polycarboxylic acid used is succinic acid.

In a second variant, a mixture of polycarboxylic acids is used in the elastomer composition, said mixture comprising at least two polycarboxylic acids as defined above. The mixture may comprise two, three, four or more than four polycarboxylic acids.

Preferably, the polycarboxylic acids of the mixture are then chosen from adipic acid, succinic acid, ethylsuccinic acid, glutaric acid, methylglutaric acid, oxalic acid and citric acid.

According to the invention, the mixture of polycarboxylic acids is preferably a mixture of dicarboxylic and/or tricarboxylic acids, especially a mixture of at least two, preferably of at least three, dicarboxylic and/or tricarboxylic acids, in particular a mixture of three dicarboxylic and/or tricarboxylic acids.

Preferably, the mixture of polycarboxylic acids is a mixture of dicarboxylic acids, especially a mixture of at least three dicarboxylic acids, in particular a mixture of three dicarboxylic acids. In general, the mixture consists of three dicarboxylic acids, although impurities may be present in an amount generally not exceeding 2.00% by weight of the total mixture.

In a first preferred embodiment of this variant of the invention, the mixture of polycarboxylic acids used in the invention comprises the following acids: adipic acid, glutaric acid and succinic acid. For example, the mixture of polycarboxylic acids comprises from 15.00% to 35.00% by weight of adipic acid, from 40.00% to 60.00% by weight of glutaric acid and from 15.00% to 25.00% by weight of succinic acid.

The mixture of polycarboxylic acids according to this first preferred embodiment of this variant of the invention may be derived from a process for the manufacture of adipic acid.

In a second preferred embodiment of this variant of the invention, the mixture of polycarboxylic acids used in the invention comprises the following acids: methylglutaric acid, ethylsuccinic acid and adipic acid. For example, the mixture of polycarboxylic acids comprises from 60.00% to 96.00% by weight of methylglutaric acid, from 3.90% to 20.00% by weight of ethylsuccinic acid and from 0.05% to 20.00% by weight of adipic acid.

The mixture of polycarboxylic acids according to this second preferred embodiment of this variant of the invention may be derived from a process for the manufacture of adipic acid.

Advantageously, the mixture of polycarboxylic acids according to this second preferred embodiment may be obtained by acid hydrolysis, preferably by basic hydrolysis, of a mixture of methylglutaronitrile, ethylsuccinonitrile and adiponitrile resulting from the process for the manufacture of adiponitrile by hydrocyanation of butadiene, adiponitrile being an important intermediate in the synthesis of hexamethylenediamine.

Some or all of the polycarboxylic acid(s), in particular of the dicarboxylic and/or tricarboxylic acids, used according to the invention may be in the anhydride, ester, alkali metal (for example sodium or potassium) salt (carboxylate), alkaline-earth metal (for example calcium) salt (carboxylate) or ammonium salt (carboxylate) form.

Advantageously, some or all of the polycarboxylic acid(s) used according to the invention may be in the form of a derivative chosen from anhydrides, alkali metal (for example sodium or potassium) salts (carboxylates), alkaline-earth metal (for example calcium) salts (carboxylates) and ammonium salts (carboxylates).

For example, the mixture of polycarboxylic acids can be a mixture comprising:
methylglutaric acid (in particular from 60.00% to 96.00% by weight, for example from 90.00% to 95.50% by weight),
ethylsuccinic anhydride (in particular from 3.90% to 20.00% by weight, for example from 3.90% to 9.70% by weight),
adipic acid (in particular from 0.05% to 20.00% by weight, for example from 0.10% to 0.30% by weight).

The mixture of polycarboxylic acids can also be a mixture comprising:
methylglutaric acid (in particular from 10.00% to 50.00% by weight, for example from 25.00% to 40.00% by weight),
methylglutaric anhydride (in particular from 40.00% to 80.00% by weight, for example from 55.00% to 70.00% by weight),
ethylsuccinic anhydride (in particular from 3.90% to 20.00% by weight, for example from 3.90% to 9.70%),
adipic acid (in particular from 0.05% to 20.00% by weight, for example from 0.10% to 0.30% by weight).

The mixtures used according to the invention can optionally comprise impurities.

The polycarboxylic acid(s) may be used in aqueous solution form.

When they are used in solid form, the polycarboxylic acid(s) may be in powder form, or may be incorporated beforehand into a polymer matrix (masterbatch). They may also be in supported form on a solid that is compatible with their structure: thus, the polycarboxylic acid(s) in liquid form are preabsorbed onto a powder.

According to the invention, the elastomer composition in which the polycarboxylic acid(s) are used according to the invention comprises a precipitated silica as reinforcing inorganic filler.

According to a preferred variant, the precipitated silica used according to the invention is a highly dispersible silica.

The term “highly dispersible silica” means in particular any silica with a very high capacity for deagglomeration and dispersion in a polymer matrix, which may especially be observed by electronic or optical microscopy, on thin slices.

Preferably, the precipitated silica used according to the invention has a CTAB specific surface area of between 70 and 350 m²/g.

This specific surface area may be between 70 and 100 m²/g, for example between 75 and 95 m²/g.

Preferably, however, the CTAB specific surface area of the precipitated silica according to the invention is between 100 and 350 m²/g, in particular between 100 and 290 m²/g, for example between 140 and 280 m²/g. It may especially be between 140 and 200 m²/g.

Likewise, preferably, the precipitated silica used according to the invention has a BET specific surface area of between 70 and 370 m²/g.

This specific surface area may be between 70 and 100 m²/g, for example between 75 and 95 m²/g.

Preferably, however, the BET specific surface area of the precipitated silica used according to the invention is between 100 and 370 m²/g, in particular between 100 and 310 m²/g, for example between 140 and 300 m²/g. It may especially be between 140 and 200 m²/g.

The BET specific surface area is determined according to the BRUNAUER-EMMETT-TELLER method described in The Journal of the American Chemical Society, Vol. 60, page 309, February 1938, and corresponding to standard NF ISO 5794-1, Appendix D (June 2010). The CTAB specific surface area is the external surface, which can be determined according to standard NF ISO 5794-1, Appendix G (June 2010).

The capacity for dispersion (and deagglomeration) of the silica used according to the invention may be assessed by means of the specific deagglomeration test below.

A particle size measurement is carried out (by laser diffraction) on a suspension of silica deagglomerated beforehand by ultrasonication; the ability of the silica to deagglomerate (cleavage of the objects from 0.1 to several tens of microns) is thus measured. The deagglomeration under ultrasound is carried out using a Vibracell Bioblock (600 W) sonicator equipped with a probe having a diameter of 19 mm. The particle size measurement is carried out by laser diffraction on a Sympatec Helios/BF particle sizer (equipped with an optical lens of R3 (0.9-175 μm) type), employing the Fraunhofer theory.

2 grams (+/−0.1 gram) of silica are introduced into a 50 ml beaker (height: 7.5 cm and diameter: 4.5 cm) and the weight is made up to 50 grams by addition of 48 grams (+/−0.1 gram) of deionized water. A 4% aqueous silica suspension is thus obtained.

The deagglomeration under ultrasound is subsequently carried out as follows: the “TIMER” button of the sonicator is pressed and the time is adjusted to 5 minutes 30 seconds. The amplitude of the probe (corresponding to the nominal power) is adjusted to 80% and then the ultrasound probe is immersed over 5 centimeters in the silica suspension present in the beaker. The ultrasound probe is then switched on and the deagglomeration is carried out for 5 minutes 30 seconds at 80% amplitude of the probe.

The particle size measurement is subsequently carried out by introducing, into the vessel of the particle sizer, a volume V (expressed in ml) of the suspension, this volume V being such that 8% optical density is achieved on the particle sizer.

The median diameter Ø₅₀, after deagglomeration with ultrasound, is such that 50% of the particles by volume have a size of less than Ø₅₀ and 50% have a size of greater than Ø₅₀. The value of the median diameter Ø₅₀ which is obtained decreases in proportion as the ability of the silica to deagglomerate increases.

It is also possible to determine the ratio (10×V/optical density of the suspension detected by the particle sizer), this optical density corresponding to the true value detected by the particle sizer during the introduction of the silica.

This ratio (deagglomeration factor F_{D}) is indicative of the content of particles with a size of less than 0.1 μm which are not detected by the particle sizer. This ratio increases in proportion as the ability of the silica to deagglomerate increases.

In general, the precipitated silica used according to the invention has a median diameter Ø₅₀, after deagglomeration with ultrasound, of less than 5.0 μm, especially less than 4.5 μm, and in particular of not more than 4.0 μm.

It usually has an ultrasound deagglomeration factor F_{D} of greater than 4.5 ml, especially greater than 5.5 ml, and in particular greater than 9.0 ml.

The pH of the silica used according to the invention is generally between 6.0 and 7.5.

The pH is measured according to the following method deriving from standard ISO 787/9 (pH of a 5% suspension in water):

Equipment:
calibrated pH meter (accuracy of reading to 1/100^{th})
combined glass electrode
200 ml beaker
100 ml measuring cylinder
balance accurate to within 0.01 g.

Procedure:

5 grams of silica are weighed out to within 0.01 gram in the 200 ml beaker. 95 ml of water, measured using the graduated measuring cylinder, are then added to the silica powder. The suspension thus obtained is vigorously stirred (magnetic stirring) for 10 minutes. The pH measurement is then carried out.

The precipitated silica to be used according to the invention may be in any physical state, i.e. it may be in the form of substantially spherical beads (microbeads), a powder or granules.

It may thus be in the form of substantially spherical beads with a mean size of at least 80 μm, preferably of at least 150 μm, in particular of between 150 and 300 μm, for example between 150 and 270 μm; this mean size is determined according to standard NF X 11507 (December 1970) by dry sieving and determination of the diameter corresponding to a cumulative oversize of 50%.

It may also be in the form of a powder with a mean size of at least 3 μm, in particular of at least 10 μm, preferably of at least 15 μm. This size is, for example, between 15 and 60 μm.

It may be in the form of granules (generally of substantially parallelepipedal shape) with a size of at least 1 mm, for example of between 1 and 10 mm, in particular along the axis of their greatest dimension.

The precipitated silica used in the invention preferably has satisfactory dispersibility in the elastomer compositions.

The precipitated silica used in the context of the invention as defined above may be obtained, for example, via a preparation process comprising a precipitation reaction of a silicate, in particular of an alkali metal silicate (for example sodium silicate) with an acidifying agent (for example sulfuric acid). A suspension of precipitated silica is then obtained. The precipitated silica obtained is then separated out, in particular by filtration, with production of a filter cake, and dried, generally by atomization.

Precipitated silica can be prepared according to any process: in particular, addition of acidifying agent to a silicate tailstock or total or partial simultaneous addition of acidifying agent and silicate to a tailstock comprising water and silicate.

The precipitated silica used in the invention may be prepared, for example, via a process as described in patents EP 0 520 862, EP 0 670 813, EP 0 670 814 and EP 0 901 986.

The precipitated silica used in the invention may be a treated silica (for example “doped” with a cation such as aluminum).

It may be prepared, for example, via a process as described in patents EP0762992, EP0762993 and EP0983966 and in applications EP1355856 and WO2011/117400.

The precipitated silica used in the invention may also be prepared, for example, via a process as described in patents EP0917519 and applications WO03/016215 and WO2009/112458.

As precipitated silica used according to the invention, use may be made of a commercially available precipitated silica, in particular a commercial highly dispersible silica. As examples of commercial silicas that may be used, mention may be made, inter alia, of the silicas Zeosil 1165MP, Zeosil 1115MP, Zeosil Premium 200MP, Zeosil 1085GR, Zeosil 195HR, Zeosil HRS 1200MP, Ultrasil 5000GR, Ultrasil 7000GR, Ultrasil 9000GR, Hi-Sil EZ 160G-D, Hi-Sil EZ 150G, Hi-Sil HDP-320G, Hi-Sil 255CG-D and Zeopol 8755LS.

The elastomer composition in which the polycarboxylic acid(s) are used according to the invention comprises at least one (natural or synthetic) elastomer.

According to the invention, the elastomer composition used according to the invention comprises at least one elastomer chosen from:

(1) synthetic polyisoprenes obtained by homopolymerization of isoprene or 2-methyl-1,3-butadiene;
(2) synthetic polyisoprenes obtained by copolymerization of isoprene with one or more ethylenically unsaturated monomers selected from:

(2.1) conjugated diene monomers, other than isoprene, having from 4 to 22 carbon atoms, for instance 1,3-butadiene, 2,3-dimethyl-1,3-butadiene, 2-chloro-1,3-butadiene (or chloroprene), 1-phenyl-1,3-butadiene, 1,3-pentadiene or 2,4-hexadiene;

(2.2) vinylaromatic monomers having from 8 to 20 carbon atoms, for instance styrene, ortho-, meta- or para-methylstyrene, the commercial mixture “vinyltoluene”, para-(tert-butyl)styrene, methoxystyrenes, chlorostyrenes, vinylmesitylene, divinylbenzene or vinylnaphthalene;

(2.3) vinyl nitrile monomers having from 3 to 12 carbon atoms, for instance acrylonitrile or methacrylonitrile;

(2.4) acrylic ester monomers derived from acrylic acid or methacrylic acid with alkanols having from 1 to 12 carbon atoms, for instance methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate;

(2.5) a mixture of at least two of the abovementioned monomers (2.1) to (2.4); copolymeric polyisoprenes comprising between 20% and 99% by weight of isoprene units and between 80% and 1% by weight of diene, vinylaromatic, vinyl nitrile and/or acrylic ester units, and consisting, for example, of poly(isoprene-butadiene), poly(isoprene-styrene) and poly(isoprene-butadiene-styrene);

(3) polydienes obtained by homopolymerization of one of the abovementioned conjugated diene monomers (2.1), for instance polybutadiene and polychloroprene;
(4) polydienes obtained by copolymerization of at least two of the abovementioned conjugated dienes (2.1) together or by copolymerization of one or more abovementioned unsaturated monomers (2.2), (2.3) and/or (2.4), for instance poly(butadiene-styrene) and poly(butadiene-acrylonitrile);
(5) ternary copolymers obtained by copolymerization of ethylene, an α-olefin containing from 3 to 6 carbon atoms with an unconjugated diene monomer containing from 6 to 12 carbon atoms, for instance elastomers obtained from ethylene or propylene with an unconjugated diene monomer of the abovementioned type especially such as 1,4-hexadiene, ethyldiene-norbornene, dicyclopentadiene (EPDM elastomer);
(6) natural rubber and epoxidized natural rubber;
(7) copolymers obtained by copolymerization of isobutene and isoprene, and also the halogenated versions, in particular chlorinated or brominated versions, of these copolymers;
(8) functionalized polymers associated with the abovementioned polymers (bearing, for example, polar groups which are pendent or at the end of a chain and which can interact with silica);
(9) a mixture of at least two of the abovementioned elastomers (1) to (8).

Preferably, the elastomer composition comprises at least one elastomer chosen from:

(1) homopolymeric synthetic polyisoprenes;
(2) copolymeric synthetic polyisoprenes consisting of poly(isoprene-butadiene), poly(isoprene-styrene) and poly(isoprene-butadiene-styrene);
(3) homopolymeric synthetic polydienes consisting of polybutadiene and polychloroprene;
(4) poly(butadiene-styrene);
(5) ethylene-propylene-diene (EPDM) ternary copolymers;
(6) natural rubber and epoxidized natural rubber;
(7) butyl rubber;
(8) functionalized polymers associated with the abovementioned polymers (bearing, for example, polar groups which are pendent or at the end of a chain and which can interact with silica);
(9) a mixture of at least two of the abovementioned elastomers (1) to (8).

Even more preferably, the elastomer composition comprises at least one elastomer chosen from:

(1) polyisoprene (IR), (2) poly(isoprene-butadiene) (BIR), poly(isoprene-styrene) (SIR), poly(isoprene-butadiene-styrene) (SBIR), (3) polybutadiene (BR), (4) poly(butadiene-styrene) (SBR, especially ESBR (emulsion) or SSBR (solution)), (5) ethylene-propylene-diene (EPDM) ternary copolymers, (6) natural rubber (NR) and epoxidized natural rubber (ENR), and (8) the associated functionalized polymers thereof (bearing, for example, polar groups which are pendent or at the end of a chain and which can interact with silica).

According to a very much preferred variant of the invention, the elastomer composition comprises, as elastomers, at least a mixture of poly(butadiene-styrene) and polybutadiene, in particular a mixture of poly(butadiene-styrene) and polybutadiene.

According to a second very much preferred variant of the invention, the elastomer composition comprises, as elastomers, at least a mixture of poly(butadiene-styrene) and natural rubber, in particular a mixture of poly(butadiene-styrene) and natural rubber.

According to another very much preferred variant of the invention, the elastomer composition comprises, as elastomer, at least natural rubber, in particular only natural rubber.

Generally, the elastomer composition employed according to the invention additionally comprises all or some of the other constituents and auxiliary additives normally employed in the field of elastomeric compositions.

Thus, generally, it comprises at least one compound chosen from vulcanization agents (for example sulfur or a sulfur-donating compound (such as a thiuram derivative)), vulcanization accelerators (for example a guanidine derivative or a thiazole derivative), vulcanization activators (for example stearic acid, zinc stearate and zinc oxide, which can optionally be introduced fractionally during the preparation of the composition), carbon black, protecting agents (in particular antioxidants and/or antiozonants, for instance N-phenyl-N′-(1,3-dimethylbutyl)-p-phenylenediamine), antireversion agents (for instance hexamethylene-1,6-bis(thiosulfate) or 1,3-bis(citraconimidomethyl)benzene) or plasticizers.

It should be noted that the polycarboxylic acid(s) used according to the invention and as described in the preceding description may be mixed, prior to their use, with at least one of the auxiliary additives usually used in the field of elastomer compositions.

The elastomer compositions used according to the invention may be vulcanized with sulfur (vulcanizates are then obtained) or crosslinked, in particular with peroxides or other crosslinking systems (for example diamines or phenolic resins).

In general, the elastomer compositions used according to the invention also comprise at least one (silica/polymer) coupling agent and/or at least one covering agent; they may also comprise, inter alia, an antioxidant.

Nonlimiting examples of coupling agents that may especially be used include “symmetrical” or “unsymmetrical” polysulfide silanes; mention may more particularly be made of bis((C₁-C₄)alkoxy(C₁-C₄)alkylsilyl(C₁-C₄)alkyl)polysulfides (in particular disulfides, trisulfides or tetrasulfides), for instance bis(3-(trimethoxysilyl)propyl)polysulfides or bis(3-(triethoxysilyl)propyl)polysulfides, such as triethoxysilylpropyl tetrasulfide. Mention may also be made of monoethoxydimethylsilylpropyl tetrasulfide. Mention may also be made of silanes comprising masked or free thiol functional groups.

The coupling agent may be grafted beforehand onto the elastomer.

It may also be used in free form (i.e. not grafted beforehand) or grafted to the surface of the silica. This is likewise the case for the optional covering agent.

The coupling agent may optionally be combined with a suitable “coupling activator”, i.e. a compound which, when mixed with this coupling agent, increases the efficacy of the latter.

The weight proportion of silica in the elastomer composition may vary within a fairly wide range. It usually represents from 0.1 to 2 times by weight, in particular 0.2 to 1.5 times by weight, especially 0.2 to 0.8 times by weight (for example 0.3 to 0.7 times by weight) or 0.8 to 1.2 times by weight (for example 0.9 to 1.1 times by weight) the amount of the elastomer(s).

The silica used in the elastomer composition used according to the invention may advantageously constitute all of the reinforcing inorganic filler, and even all of the reinforcing filler, of the elastomer composition.

However, this silica used in the elastomer composition according to the invention may optionally be combined with at least one other reinforcing filler, such as, in particular, a commercial highly dispersible silica, for instance Zeosil 1165MP or Zeosil 1115MP, a treated precipitated silica (for example “doped” with a cation such as aluminum); another reinforcing inorganic filler, for instance alumina, or even a reinforcing organic filler, in particular carbon black (optionally covered with a inorganic layer, for example of silica). The silica used in the elastomer composition used according to the invention then preferably constitutes at least 50% by weight, or even at least 80% by weight, of all of the reinforcing filler.

The use according to the invention of at least one polycarboxylic acid in an elastomer composition as described in the preceding description may take place more particularly in the context of the manufacture of shoe soles (preferably in the presence of a coupling agent (silica/polymer), for example triethoxysilylpropyl tetrasulfide), floorcoverings, gas barriers, fire-retardant materials, and also technical components such as cable car rollers, seals for household electrical appliances, seals for liquid or gas pipes, brake system seals, pipes (hoses), sheathing (especially cable sheathing), cables, engine supports, battery separators, conveyor belts or transmission belts.

Advantageously, the use according to the invention of at least one polycarboxylic acid in an elastomer composition as described in the preceding description may take place in the context of the manufacture of tires, in particular tire tread bands (especially for light vehicles or for heavy goods vehicles (for example trucks)).

The elastomer compositions obtained according to the use in accordance with the invention contain an effective amount of polycarboxylic acid(s).

More particularly, the elastomer compositions resulting from the invention may comprise (parts by weight), per 100 parts of elastomer(s):

10 to 200 parts, in particular 20 to 150 parts, especially 30 to 120 parts, for example 35 to 110 parts, of precipitated silica as described above and used as reinforcing inorganic filler;

0.10 to 10.00 parts, preferably 0.15 to 5.00 parts, in particular 0.20 to 2.50 parts, especially 0.25 to 2.00 parts, for example 0.25 to 1.00 part, of polycarboxylic acid(s).

As more particular examples, the elastomer compositions derived from the invention may comprise (parts by weight), per 100 parts of elastomer(s), 20 to 80 parts, especially 30 to 70 parts, or 80 to 120 parts, especially 90 to 110 parts, of precipitated silica as described above as reinforcing inorganic filler.

The elastomer compositions derived from the invention may also comprise (parts by weight), for 100 parts of elastomer(s), 0.50 to 20.00 parts, in particular 1.00 to 15.00 parts, especially 1.50 to 12.00 parts, for example 2.00 to 10.00 parts, of a coupling agent.

Advantageously, the use according to the present invention of polycarboxylic acid(s) in elastomer compositions may give said compositions a reduction in viscosity facilitating their use, while at the same time not degrading their dynamic properties or their mechanical properties. It thus makes it possible to obtain a compromise of satisfactory implementation/reinforcement/hysteresis properties.

A second subject of the present invention is the elastomer compositions described above, thus comprising at least one elastomer, a precipitated silica as reinforcing inorganic filler and at least one polycarboxylic acid, said polycarboxylic acid not being contained in said precipitated silica.

Everything that has been described previously in the context of the use of at least one carboxylic acid according to the first subject of the invention applies to these elastomer compositions and to the process for preparing the same.

The invention, taken in its second subject, relates to elastomer compositions both in the raw state (i.e. before curing) and in the cured state (i.e. after crosslinking or vulcanization).

A third subject of the present invention is a process for preparing the elastomer compositions according to the invention, said process comprising a step of mixing at least one elastomer, a precipitated silica and at least one polycarboxylic acid.

According to this preparation process, the elastomer compositions according to the invention may be prepared according to any conventional two-phase procedure. A first phase (“nonproductive” phase) is a phase of high-temperature thermomechanical working. It is followed by a second phase of mechanical working (“productive” phase) at temperatures generally of less than 110° C., in which the vulcanization system is introduced.

The elastomer compositions according to the invention can be used to manufacture finished or semifinished articles comprising said compositions.

A fourth subject of the present invention is thus articles comprising at least one (in particular based on) said elastomer compositions described previously (especially based on the vulcanizates mentioned above), these articles consisting of shoe soles (preferably in the presence of a coupling agent (silica/polymer), for example triethoxysilylpropyl tetrasulfide), floorcoverings, gas barriers, fire-retardant materials, and also technical components such as cable car rollers, seals for household electrical appliances, seals for liquid or gas pipes, brake system seals, pipes (hoses), sheathing (especially cable sheathing), cables, engine supports, battery separators, conveyor belts or transmission belts.

Advantageously, these articles comprising at least one (in particular based on) of said elastomer compositions described previously consist of tires, in particular tire tread bands (especially for light vehicles or for heavy goods vehicles (for example trucks)).

The following examples illustrate the invention without, however, limiting the scope thereof.

### EXAMPLES

### Example 1

The elastomer compositions, the make up of which, expressed as parts by weight per 100 parts of elastomers (phr), is shown in the table below, are prepared in an internal mixer of Brabender type (380 ml):

TABLE I

| Compositions | Control 1 | Composition 1 |
|---|---|---|
| SBR (1) | 96.2 | 96.2 |
| BR (1) | 30 | 30 |
| Silica (2) | 80 | 80 |
| Mixture of polycarboxylic acids (3) | | 0.4 |
| Coupling agent (4) | 6.4 | 6.4 |
| Carbon black (N330) | 6.4 | 6.4 |
| Plasticizer (5) | 5 | 5 |
| ZnO | 2.5 | 2.5 |
| Stearic acid | 2 | 2 |
| Antioxidant (6) | 1.9 | 1.9 |
| DPG (7) | 2.0 | 2.0 |
| CBS (8) | 1.7 | 1.7 |
| Sulfur | 1.4 | 1.4 |

(1) SBR solution (Buna VSL5228-2 from the company Lanxess) with 52 ± 4% of vinyl units; 28 ± 2% of styrene units; Tg in the vicinity of −20° C.; 100 phr of SBR extended with 37.5 ± 2.8% by weight of oil/BR (Buna CB 24 from the company Lanxess)
(2) Silica Zeosil 1165MP from the company Rhodia (Solvay)
(3) mixture of AGS acids (adipic acid, glutaric acid, succinic acid from the company Rhodia - 26% by weight of adipic acid, 52% by weight of glutaric acid, 21% by weight of succinic acid, 1% others)
(4) TESPT (Luvomaxx TESPT from the company Lehvoss France sarl)
(5) Vivatec 500 from the company H&R
(6) N-(1,3-dimethylbutyl)-N-phenyl-para-phenylenediamine (Santoflex 6-PPD from the company Flexsys)
(7) Diphenylguanidine (Rhenogran DPG-80 from the company RheinChemie)
(8) N-cyclohexyl-2-benzothiazolesulfenamide (Rhenogran CBS-80 from the company RheinChemie)

Process for the Preparation of the Elastomeric Compositions

The process for the preparation of the rubber compositions is carried out in two successive preparation phases. A first phase consists of a phase of high-temperature thermomechanical working. It is followed by a second phase of mechanical working at temperatures of less than 110° C. This phase makes possible the introduction of the vulcanization system.

The first phase is carried out using a mixing device, of internal mixer type, of Brabender brand (capacity of 380 ml). The filling coefficient is 0.6. The initial temperature and the speed of the rotors are set on each occasion so as to achieve mixture dropping temperatures of approximately 140-160° C.

Broken down here into two passes, the first phase makes it possible to incorporate, in a first pass, the elastomers and then the reinforcing filler (introduction in installments) with the mixture of polycarboxylic acids, the coupling agent and the stearic acid. For this pass, the duration is between 4 and 10 minutes.

After cooling the mixture (temperature of less than 100° C.), a second pass makes it possible to incorporate the zinc oxide and the protecting agents/antioxidants (in particular 6-PPD). The duration of this pass is between 2 and 5 minutes.

After cooling the mixture (temperature of less than 100° C.), the second phase makes possible the introduction of the vulcanization system (sulfur and accelerators, such as CBS). It is carried out on an open mill, preheated to 50° C. The duration of this phase is between 2 and 6 minutes.

Each final mixture is subsequently calendered in the form of plaques with a thickness of 2-3 mm.

With regard to these “raw” mixtures obtained, an evaluation of their rheological properties makes it possible to optimize the vulcanization time and the vulcanization temperature.

Subsequently, the mechanical and dynamic properties of the mixtures vulcanized at the curing optimum (T98) are measured.

Rheological Properties

Viscosity of the Raw Mixtures

The Mooney consistency is measured on the compositions in the raw state at 100° C. using an MV 2000 rheometer and also the determination of the Mooney stress-relaxation rate according to standard NF ISO 289.

The value of the torque, read at the end of 4 minutes after preheating for one minute (Mooney Large (1+4)—at 100° C.), is shown in table II. The test is performed after preparing the raw mixtures.

TABLE II

| Compositions | Control 1 | Composition 1 |
|---|---|---|
| ML (1 + 4) - 100° C. | 89 | 77 |
| Mooney relaxation | 0.307 | 0.306 |

It is found that the composition of the present invention (Composition 1) allows a sizeable reduction in initial raw viscosity, relative to the value of the reference composition (Control 1).

This type of behavior over time is of great use to a person skilled in the art in the case of the implementation of silica-comprising rubber mixtures.

Rheometry of the Compositions

The measurements are carried out on the compositions in the raw state. The results relating to the rheology test, which is carried out at 160° C. using a Monsanto ODR rheometer according to standard NF ISO 3417, are given in table III.

According to this test, the test composition is placed in the test chamber regulated at the temperature of 160° C. for 30 minutes, and the resistive torque opposed by the composition to a low-amplitude (3°) oscillation of a biconical rotor included in the test chamber is measured, the composition completely filling the chamber under consideration.

The following are determined from the curve of variation in the torque as a function of time:
the minimum torque (Tmin), which reflects the viscosity of the composition at the temperature under consideration;
the maximum torque (Tmax);
the delta torque (ΔT=Tmax−Tmin), which reflects the degree of crosslinking brought about by the action of the crosslinking system and, if the need arises, of the coupling agents;
the time T98 necessary to obtain a vulcanization state corresponding to 98% of complete vulcanization (this time is taken as vulcanization optimum);
and the scorch time TS2, corresponding to the time necessary in order to have a rise of 2 points above the minimum torque at the temperature under consideration (160° C.) and which reflects the time during which it is possible to implement the raw mixtures at this temperature without having initiation of vulcanization (the mixture cures from TS2).
   The results obtained are shown in table III.

TABLE III

| Compositions | Control 1 | Composition 1 |
|---|---|---|
| Tmin (dN · m) | 19.8 | 17.7 |
| Tmax (dN · m) | 76.9 | 75.5 |
| Delta torque (dN · m) | 57.1 | 57.8 |
| TS 2 (min) | 2.7 | 3.7 |
| T98 (min) | 23.5 | 25.1 |

The use of the composition of the present invention (Composition 1) makes it possible to reduce the minimum viscosity (sign of an improvement in the raw viscosity) relative to the reference (Control 1) without damaging the vulcanization behavior.

Mechanical Properties of the Vulcanizates

The measurements are carried out on the optimally vulcanized compositions (T98) for a temperature of 160° C.

Uniaxial tensile tests are carried out in accordance with the instructions of standard NF ISO 37 with test specimens of H2 type at a rate of 500 mm/min on an Instron 5564 device. The x % moduli, corresponding to the stress measured at x % of tensile strain, and the ultimate strength are expressed in MPa; the elongation at break is expressed in %. It is possible to determine a reinforcing index (RI) which is equal to the ratio of the modulus at 300% strain to the modulus at 100% strain.

The Shore A hardness measurement of the vulcanizates is carried out according to the instructions of standard ASTM D 2240. The given value is measured at 15 seconds.

The properties measured are collated in table IV.

TABLE IV

| Compositions | Control 1 | Composition 1 |
|---|---|---|
| 10% Modulus (MPa) | 0.6 | 0.6 |
| 100% Modulus (MPa) | 2.7 | 2.6 |
| 300% Modulus (MPa) | 14.6 | 14.3 |
| Ultimate strength (MPa) | 19.4 | 19.3 |
| Elongation at break (%) | 370 | 375 |
| RI | 5.4 | 5.5 |
| Shore A hardness - 15 s (pts) | 63 | 62 |

It is found that the composition resulting from the invention (Composition 1) has a compromise of mechanical properties similar to that obtained with the control composition.

The use of the composition of the present invention (Composition 1) makes it possible to maintain a good level of reinforcement.

Dynamic Properties of the Vulcanizates

The dynamic properties are measured on a viscosity analyzer (Metravib VA3000) according to standard ASTM D 5992.

The values for loss factor (tan δ) and compressive dynamic complex modulus (E*) are recorded on vulcanized samples (cylindrical test specimen with a cross section of 95 mm² and a height of 14 mm). The sample is subjected at the start to a 10% prestrain and then to a sinusoidal strain in alternating compression of plus or minus 2%. The measurements are carried out at 60° C. and at a frequency of 10 Hz.

The results, presented in table V, are the compressive complex modulus (E*, 60° C., 10 Hz) and the loss factor (tan δ, 60° C., 10 Hz).

The values for the loss factor (tan δ) and amplitude of dynamic shear elastic modulus (ΔG′) are recorded on vulcanized samples (parallelepipedal test specimen with a cross section of 8 mm² and a height of 7 mm). The sample is subjected to a double alternating sinusoidal shear strain at a temperature of 40° C. and at a frequency of 10 Hz. The strain amplitude sweeping processes are carried out according to an outward-return cycle, proceeding outward from 0.1% to 50% and then returning from 50% to 0.1%.

The results, presented in table V, result from the return strain amplitude sweep and relate to the maximum value of the loss factor (tan δ max return, 40° C., 10 Hz) and to the amplitude of the elastic modulus (ΔG′, 40° C., 10 Hz) between the values at 0.1% and 50% strain (Payne effect).

TABLE V

| Compositions | Control 1 | Composition 1 |
|---|---|---|
| E*, 60° C., 10 Hz (MPa) | 8.6 | 8.4 |
| Tan δ, 60° C., 10 Hz | 0.128 | 0.123 |
| ΔG′, 40° C., 10 Hz (MPa) | 2.0 | 1.9 |
| Tan δ max return, 40° C., 10 Hz | 0.223 | 0.217 |

The use of the composition of the present invention (Composition 1) makes it possible to obtain similar values in terms of the maximum value of the loss factor and the amplitude of the elastic modulus (or Payne effect), relative to the reference (Control 1).

Examination of the various tables II to V shows that the composition in accordance with the invention (Composition 1) makes it possible to obtain a satisfactory compromise of implementation/reinforcement/hysteresis properties, in particular an improvement of the implementation (gain in viscosity), without deteriorating the mechanical and dynamic properties, relative to the reference (Control 1).

### Example 2

The elastomer compositions, the make up of which, expressed as parts by weight per 100 parts of elastomers (phr), is shown in table VI below, are prepared in an internal mixer of Haake type (380 ml):

TABLE VI

| Compositions | Control 2 | Composition 2 |
|---|---|---|
| SBR (1) | 103 | 103 |
| NR (1) | 25 | 25 |
| Silica (2) | 80 | 80 |
| Mixture of polycarboxylic acids (3) | — | 0.8 |
| Coupling agent (4) | 6.4 | 6.4 |
| Carbon black (N330) | 3.0 | 3.0 |
| ZnO | 2.5 | 2.5 |
| Stearic acid | 2.0 | 2.0 |
| Antioxidant 1 (5) | 1.9 | 1.9 |
| DPG (6) | 1.5 | 1.5 |
| CBS (7) | 1.7 | 1.7 |
| Sulfur | 1.1 | 1.1 |

(1) SBR solution (Buna VSL 5228-2 from the company Lanxess) with 52 ± 4% of vinyl units; 28 ± 2% of styrene units; Tg in the vicinity of −20° C.; 100 phr of SBR extended with 37.5 ± 2.8% by weight of oil/natural rubber CVR CV60 (supplied by the company Safic-Alcan)
(2) Silica Zeosil 1165MP from the company Rhodia (Solvay)
(3) mixture of MGA acids (methylglutaric acid, ethylsuccinic acid and adipic acid from the company Rhodia - 94.8% by weight of methylglutaric acid, 4.9% by weight of ethylsuccinic anhydride, 0.2% by weight of adipic acid, 0.1% others)
(4) TESPT (Luvomaxx TESPT from the company Lehvoss France sarl)
(5) N-(1,3-dimethylbutyl)-N-phenyl-para-phenylenediamine (Santoflex 6-PPD from the company Flexsys)
(6) Diphenylguanidine (Rhenogran DPG-80 from the company RheinChemie)
(7) N-cyclohexyl-2-benzothiazolesulfenamide (Rhenogran CBS-80 from the company RheinChemie)

Process for the Preparation of the Elastomeric Compositions

The process for the preparation of the rubber compositions is carried out in two successive preparation phases. A first phase consists of a phase of high-temperature thermomechanical working. It is followed by a second phase of mechanical working at temperatures of less than 110° C. This phase makes possible the introduction of the vulcanization system.

The first phase is carried out using a mixing device, of internal mixer type, of Haake brand (capacity of 380 ml). The filling coefficient is 0.6. The initial temperature and the speed of the rotors are set on each occasion so as to achieve mixture dropping temperatures of approximately 140-160° C.

Broken down here into two passes, the first phase makes it possible to incorporate, in a first pass, the elastomers and then the reinforcing filler (introduction in installments) with the mixture of polycarboxylic acids, the coupling agent and the stearic acid. For this pass, the duration is between 4 and 10 minutes.

After cooling the mixture (temperature of less than 100° C.), a second pass makes it possible to incorporate the zinc oxide and the protecting agents/antioxidants (in particular 6-PPD). The duration of this pass is between 2 and 5 minutes.

After cooling the mixture (temperature of less than 100° C.), the second phase makes possible the introduction of the vulcanization system (sulfur and accelerators, such as CBS). It is carried out on an open mill, preheated to 50° C. The duration of this phase is between 2 and 6 minutes.

Each final mixture is subsequently calendered in the form of plaques with a thickness of 2-3 mm.

With regard to these “raw” mixtures obtained, an evaluation of their rheological properties makes it possible to optimize the vulcanization time and the vulcanization temperature.

Subsequently, the mechanical and dynamic properties of the mixtures vulcanized at the curing optimum (T98) are measured.

Rheological Properties

Viscosity of the Raw Mixtures

The Mooney consistency is measured on the compositions in the raw state at 100° C. using an MV 2000 rheometer and also the determination of the Mooney stress-relaxation rate according to standard NF ISO 289.

The value of the torque, read at the end of 4 minutes after preheating for one minute (Mooney Large (1+4)—at 100° C.), is shown in table VII. The test is performed after preparing the raw mixtures.

TABLE VII

| Compositions | Control 2 | Composition 2 |
|---|---|---|
| ML (1 + 4) - 100° C. | 78 | 73 |
| Mooney relaxation | 0.292 | 0.304 |

It is found that the composition of the present invention (Composition 2) allows a sizeable reduction in initial raw viscosity, relative to the reference (Control 2).

This type of behavior over time is of great use to a person skilled in the art in the case of the implementation of silica-comprising rubber mixtures.

Rheometry of the Compositions

The measurements are carried out on the compositions in the raw state. The results relating to the rheology test, which is carried out at 160° C. using a Monsanto ODR rheometer according to standard NF ISO 3417, are given in table VIII.

According to this test, the test composition is placed in the test chamber regulated at the temperature of 160° C. for 30 minutes, and the resistive torque opposed by the composition to a low-amplitude (3°) oscillation of a biconical rotor included in the test chamber is measured, the composition completely filling the chamber under consideration.

The following are determined from the curve of variation in the torque as a function of time:
the minimum torque (Tmin), which reflects the viscosity of the composition at the temperature under consideration;
the maximum torque (Tmax);
the delta torque (ΔT=Tmax−Tmin), which reflects the degree of crosslinking brought about by the action of the crosslinking system and, if the need arises, of the coupling agents;
the time T98 necessary to obtain a vulcanization state corresponding to 98% of complete vulcanization (this time is taken as vulcanization optimum);
and the scorch time TS2, corresponding to the time necessary in order to have a rise of 2 points above the minimum torque at the temperature under consideration (160° C.) and which reflects the time during which it is possible to implement the raw mixtures at this temperature without having initiation of vulcanization (the mixture cures from TS2).

The results obtained are shown in table VIII.

TABLE VIII

| Compositions | Control 2 | Composition 2 |
|---|---|---|
| Tmin (dN · m) | 15.3 | 13.6 |
| Tmax (dN · m) | 53.6 | 52.0 |
| Delta torque (dN · m) | 38.3 | 38.4 |
| TS2 (min) | 3.7 | 4.9 |
| T98 (min) | 25.4 | 24.8 |

The use of the composition of the present invention (Composition 2) makes it possible to reduce the minimum viscosity (sign of an improvement in the raw viscosity) relative to the reference (Control 2) without damaging the vulcanization behavior.

Mechanical Properties of the Vulcanizates

The measurements are carried out on the optimally vulcanized compositions (T98) for a temperature of 160° C.

Uniaxial tensile tests are carried out in accordance with the instructions of standard NF ISO 37 with test specimens of H2 type at a rate of 500 mm/min on an Instron 5564 device. The x % moduli, corresponding to the stress measured at x % of strain, and the ultimate strength are expressed in MPa; the elongation at break is expressed in %. It is possible to determine a reinforcing index (RI) which is equal to the ratio of the modulus at 300% strain to the modulus at 100% strain.

The Shore A hardness measurement of the vulcanizates is carried out according to the instructions of standard ASTM D 2240. The given value is measured at 15 seconds.

The properties measured are collated in table IX.

TABLE IX

| Compositions | Control 2 | Composition 2 |
|---|---|---|
| 10% Modulus (MPa) | 0.5 | 0.5 |
| 100% Modulus (MPa) | 2.5 | 2.3 |
| 300% Modulus (MPa) | 15.3 | 13.9 |
| Ultimate strength (MPa) | 20.4 | 20.0 |
| Elongation at break (%) | 374 | 386 |
| RI | 6.1 | 6.0 |
| Shore A hardness - 15 s (pts) | 56 | 55 |

It is found that the composition of the present invention (Composition 2) has a compromise of mechanical properties similar to that obtained with the control composition.

The use of the composition of the present invention (Composition 2) makes it possible to maintain a level of reinforcement similar to that of the reference (Control 2).

Dynamic Properties of the Vulcanizates

The dynamic properties are measured on a viscosity analyzer (Metravib VA3000) according to standard ASTM D 5992.

The values for loss factor (tan δ) and compressive dynamic complex modulus (E*) are recorded on vulcanized samples (cylindrical test specimen with a cross section of 95 mm² and a height of 14 mm). The sample is subjected at the start to a 10% prestrain and then to a sinusoidal strain in alternating compression of plus or minus 2%. The measurements are carried out at 60° C. and at a frequency of 10 Hz.

The results, presented in table X, are the compressive complex modulus (E*, 60° C., 10 Hz) and the loss factor (tan δ, 60° C., 10 Hz).

The values for the loss factor (tan δ) and amplitude of dynamic shear elastic modulus (ΔG′) are recorded on vulcanized samples (parallelepipedal test specimen with a cross section of 8 mm² and a height of 7 mm). The sample is subjected to a double alternating sinusoidal shear strain at a temperature of 40° C. and at a frequency of 10 Hz. The strain amplitude sweeping processes are carried out according to an outward-return cycle, proceeding outward from 0.1% to 50% and then returning from 50% to 0.1%.

The results, presented in table X, result from the return strain amplitude sweep and relate to the maximum value of the loss factor (tan δ max return, 40° C., 10 Hz) and to the amplitude of the elastic modulus (ΔG′, 40° C., 10 Hz) between the values at 0.1% and 50% strain (Payne effect).

TABLE X

| Compositions | Control 2 | Composition 3 |
|---|---|---|
| E*, 60° C., 10 Hz (MPa) | 5.5 | 5.4 |
| Tan δ, 60° C., 10 Hz | 0.120 | 0.119 |
| ΔG′, 40° C., 10 Hz (MPa) | 1.13 | 1.11 |
| Tan δ max return, 40° C., 10 Hz | 0.202 | 0.189 |

The use of the composition of the present invention (Composition 2) makes it possible to obtain similar values in terms of the maximum value of the loss factor and the amplitude of the elastic modulus or Payne effect, relative to the reference (Control 2).

Examination of the various tables VII to X shows that the composition in accordance with the invention (Composition 2) makes it possible to obtain a satisfactory compromise of implementation/reinforcement/hysteresis properties, in particular an improvement of the implementation (gain in viscosity), without deteriorating the mechanical and dynamic properties, relative to the control composition (Control 2).

### Example 3

The elastomer compositions, the make up of which, expressed as parts by weight per 100 parts of elastomers (phr), is shown in the table below, are prepared in an internal mixer of Brabender type (380 ml):

TABLE XI

| Compositions | Control 3 | Composition 3 |
|---|---|---|
| NR (1) | 100 | 100 |
| Silica (2) | 38 | 38 |
| Carbon black (N234) | 17 | 17 |
| Dicarboxylic acid (3) | — | 0.4 |
| Coupling agent (4) | 3 | 3 |
| ZnO | 3 | 3 |
| Stearic acid | 2.5 | 2.5 |
| Antioxidant 1 (5) | 1.5 | 1.5 |
| Antioxidant 2 (6) | 1.0 | 1.0 |
| Carbon black (N330) | 3 | 3 |
| CBS (7) | 2.2 | 2.2 |
| Sulfur | 1.5 | 1.5 |
| TBzTD (8) | 0.2 | 0.2 |

(1) Natural rubber CVR CV60 (supplied by the company Safic-Alcan)
(2) Silica Zeosil 1165MP from the company Rhodia (Solvay)
(3) Succinic acid (from the company Aldrich)
(4) TESPT (Luvomaxx TESPT from the company Lehvoss France sarl)
(5) N-(1,3-dimethylbutyl)-N-phenyl-para-phenylenediamine (Santoflex 6-PPD from the company Flexsys)
(6) 2,2,4-trimethyl-1H-quinoline (Permanax TQ from the company Flexsys)
(7) N-cyclohexyl-2-benzothiazolesulfenamide (Rhenogran CBS-80 from the company RheinChemie)
(8) Tetrabenzylthiuram disulfide (Rhenogran TBzTD-70 from the company RheinChemie)

Process for the Preparation of the Elastomeric Compositions

The process for the preparation of the rubber compositions is carried out in two successive preparation phases. A first phase consists of a phase of high-temperature thermomechanical working. It is followed by a second phase of mechanical working at temperatures of less than 110° C. This phase makes possible the introduction of the vulcanization system.

The first phase is carried out using a mixing device, of internal mixer type, of Brabender brand (capacity of 380 ml). The filling coefficient is 0.6. The initial temperature and the speed of the rotors are set on each occasion so as to achieve mixture dropping temperatures of approximately 140-160° C.

Broken down here into two passes, the first phase makes it possible to incorporate, in a first pass, the elastomers and then the reinforcing filler (introduction in installments) with the polycarboxylic acid, the coupling agent and the stearic acid. For this pass, the duration is between 4 and 10 minutes.

After cooling the mixture (temperature of less than 100° C.), a second pass makes it possible to incorporate the zinc oxide and the protecting agents/antioxidants (in particular 6-PPD). The duration of this pass is between 2 and 5 minutes.

After cooling the mixture (temperature of less than 100° C.), the second phase makes possible the introduction of the vulcanization system (sulfur and accelerators, such as CBS). It is carried out on an open mill, preheated to 50° C. The duration of this phase is between 2 and 6 minutes.

Each final mixture is subsequently calendered in the form of plaques with a thickness of 2-3 mm.

With regard to these “raw” mixtures obtained, an evaluation of their rheological properties makes it possible to optimize the vulcanization time and the vulcanization temperature.

Subsequently, the mechanical and dynamic properties of the mixtures vulcanized at the curing optimum (T98) are measured.

Rheological Properties

Viscosity of the Raw Mixtures

The Mooney consistency is measured on the compositions in the raw state at 100° C. using an MV 2000 rheometer and also the determination of the Mooney stress-relaxation rate according to standard NF ISO 289.

The value of the torque, read at the end of 4 minutes after preheating for one minute (Mooney Large (1+4)—at 100° C.), is shown in table XII. The test is performed after preparing the raw mixtures.

TABLE XII

| Compositions | Control 3 | Composition 3 |
|---|---|---|
| ML (1 + 4) - 100° C. | 61 | 56 |
| Mooney relaxation | 0.365 | 0.418 |

It is found that the composition of the present invention (Composition 3) allows a satisfactory reduction in initial raw viscosity, relative to the value of the reference composition (Control 3).

This type of behavior over time is of great use to a person skilled in the art in the case of the implementation of silica-comprising rubber mixtures.

Rheometry of the Compositions

The measurements are carried out on the compositions in the raw state. The results relating to the rheology test, which is carried out at 150° C. using a Monsanto ODR rheometer according to standard NF ISO 3417, are given in table XIII.

According to this test, the test composition is placed in the test chamber regulated at the temperature of 150° C. for 30 minutes, and the resistive torque opposed by the composition to a low-amplitude (3°) oscillation of a biconical rotor included in the test chamber is measured, the composition completely filling the chamber under consideration.

The following are determined from the curve of variation in the torque as a function of time:
the minimum torque (Tmin), which reflects the viscosity of the composition at the temperature under consideration;
the maximum torque (Tmax);
the delta torque (ΔT=Tmax−Tmin), which reflects the degree of crosslinking brought about by the action of the crosslinking system and, if the need arises, of the coupling agents;
the time T98 necessary to obtain a vulcanization state corresponding to 98% of complete vulcanization (this time is taken as vulcanization optimum);
and the scorch time TS2, corresponding to the time necessary in order to have a rise of 2 points above the minimum torque at the temperature under consideration (150° C.) and which reflects the time during which it is possible to implement the raw mixtures at this temperature without having initiation of vulcanization (the mixture cures from TS2).
   The results obtained are shown in table XIII.

TABLE XIII

| Compositions | Control 3 | Composition 3 |
|---|---|---|
| Tmin (dN · m) | 12.2 | 10.8 |
| Tmax (dN · m) | 94.1 | 92.0 |
| Delta torque (dN · m) | 81.9 | 81.1 |
| TS 2 (min) | 4.8 | 5.0 |
| T98 (min) | 9.8 | 11.2 |

The use of the composition of the present invention (Composition 3) makes it possible to reduce the minimum viscosity (sign of an improvement in the raw viscosity) relative to the reference (Control 3) without damaging the vulcanization behavior.

Mechanical Properties of the Vulcanizates

The measurements are carried out on the optimally vulcanized compositions (T98) for a temperature of 150° C.

Uniaxial tensile tests are carried out in accordance with the instructions of standard NF ISO 37 with test specimens of H2 type at a rate of 500 mm/min on an Instron 5564 device. The x % moduli, corresponding to the stress measured at x % of tensile strain, and the ultimate strength are expressed in MPa; the elongation at break is expressed in %. It is possible to determine a reinforcing index (RI) which is equal to the ratio of the modulus at 300% strain to the modulus at 100% strain.

The Shore A hardness measurement of the vulcanizates is carried out according to the instructions of standard ASTM D 2240. The given value is measured at 15 seconds.

The properties measured are collated in table XIV.

TABLE XIV

| Compositions | Control 3 | Composition 3 |
|---|---|---|
| 10% Modulus (MPa) | 0.8 | 0.8 |
| 100% Modulus (MPa) | 4.6 | 4.4 |
| 300% Modulus (MPa) | 20.1 | 18.9 |
| Ultimate strength (MPa) | 28.1 | 26.6 |
| Elongation at break (%) | 430 | 429 |
| RI | 4.4 | 4.3 |
| Shore A hardness - 15 s (pts) | 66 | 67 |

It is found that the composition resulting from the invention (Composition 3) has a compromise of mechanical properties similar to that obtained with the control composition.

The use of the composition of the present invention (Composition 3) makes it possible to maintain a good level of reinforcement relative to the reference composition (Control 3).

Dynamic Properties of the Vulcanizates

The dynamic properties are measured on a viscosity analyzer (Metravib VA3000) according to standard ASTM D 5992.

The values for loss factor (tan δ) and compressive dynamic complex modulus (E*) are recorded on vulcanized samples (cylindrical test specimen with a cross section of 95 mm² and a height of 14 mm). The sample is subjected at the start to a 10% prestrain and then to a sinusoidal strain in alternating compression of plus or minus 2%. The measurements are carried out at 60° C. and at a frequency of 10 Hz.

The results, presented in table XV, are the compressive complex modulus (E*, 60° C., 10 Hz) and the loss factor (tan δ, 60° C., 10 Hz).

The values for the loss factor (tan δ) and amplitude of dynamic shear elastic modulus (ΔG′) are recorded on vulcanized samples (parallelepipedal test specimen with a cross section of 8 mm² and a height of 7 mm). The sample is subjected to a double alternating sinusoidal shear strain at a temperature of 60° C. and at a frequency of 10 Hz. The strain amplitude sweeping processes are carried out according to an outward-return cycle, proceeding outward from 0.1% to 50% and then returning from 50% to 0.1%.

The results, presented in table XV, result from the return strain amplitude sweep and relate to the maximum value of the loss factor (tan δ max return, 60° C., 10 Hz) and to the amplitude of the elastic modulus (ΔG′, 60° C., 10 Hz) between the values at 0.1% and 50% strain (Payne effect).

TABLE XV

| Compositions | Control 3 | Composition 3 |
|---|---|---|
| E*, 60° C., 10 Hz (MPa) | 7.6 | 7.6 |
| Tan δ, 60° C., 10 Hz | 0.071 | 0.072 |
| ΔG′, 60° C., 10 Hz (MPa) | 2.8 | 2.2 |
| Tan δ max return, 60° C., 10 Hz | 0.122 | 0.121 |

The use of the composition of the present invention (Composition 3) makes it possible to obtain similar values in terms of the maximum value of the loss factor and the amplitude of the elastic modulus (or Payne effect), relative to the reference (Control 3).

Examination of the various tables XII to XV shows that the composition in accordance with the invention (Composition 3) makes it possible to obtain a satisfactory compromise of implementation/reinforcement/hysteresis properties, in particular an improvement of the implementation (gain in viscosity), without deteriorating the mechanical and dynamic properties, relative to the reference (Control 3).

1-2. (canceled)

3. A method for reducing the viscosity of an elastomer composition, the method comprising incorporating a polycarboxylic acid and a precipitated silica as reinforcing inorganic filler, independently of each other, into at least one elastomer.

4. An elastomer composition comprising at least one elastomer, a precipitated silica as reinforcing filler and at least one polycarboxylic acid, said polycarboxylic acid not being contained in said precipitated silica.

5. (canceled)

6. The composition as claimed in claim 4, wherein said polycarboxylic acid is an acid selected from linear or branched, saturated or unsaturated aliphatic polycarboxylic acids containing from 2 to 20 carbon atoms and aromatic polycarboxylic acids containing from 7 to 20 carbon atoms.

7. The composition as claimed in claim 5, wherein the polycarboxylic acid is at least one dicarboxylic or tricarboxylic acid an acid selected from adipic acid, succinic acid, ethylsuccinic acid, glutaric acid, methylglutaric acid, oxalic acid and citric acid.

8. The composition as claimed in claim 7, wherein said polycarboxylic acid is succinic acid.

9. The composition as claimed in claim 4, wherein the polycarboxylic acid is a mixture of polycarboxylic acids.

10-11. (canceled)

12. The composition as claimed in claim 9, wherein the mixture of polycarboxylic acids comprises adipic acid, glutaric acid and succinic acid.

13. (canceled)

14. The composition as claimed in claim 9, wherein the mixture of polycarboxylic acids comprises: methylglutaric acid, ethylsuccinic acid and adipic acid.

15-19. (canceled)

20. The composition as claimed in claim 4, wherein said precipitated silica has a CTAB specific surface area of between 100 and 350 m²/g.

21. The composition as claimed in claim 4, wherein said precipitated silica has a BET specific surface area of between 100 and 370 m²/g.

22. The composition as claimed in claim 4, wherein said elastomer composition comprises at least one elastomer selected from:
(1) synthetic polyisoprenes obtained by homopolymerization of isoprene or 2-methyl-1,3-butadiene;
(2) synthetic polyisoprenes obtained by copolymerization of isoprene with one or more ethylenically unsaturated monomers selected from:
(2.1) conjugated diene monomers, other than isoprene, having from 4 to 22 carbon atoms;
(2.2) vinylaromatic monomers having from 8 to 20 carbon atoms;
(2.3) vinyl nitrile monomers having from 3 to 12 carbon atoms;
(2.4) acrylic ester monomers derived from acrylic acid or methacrylic acid with alkanols having from 1 to 12 carbon atoms;
(2.5) a mixture of at least two of the abovementioned monomers (2.1) to (2.4); copolymeric polyisoprenes comprising between 20% and 99% by weight of isoprene units and between 80% and 1% by weight of diene, vinylaromatic, vinyl nitrile and/or acrylic ester units;
(3) polydienes obtained by homopolymerization of one of the abovementioned conjugated diene monomers (2.1);
(4) polydienes obtained by copolymerization of at least two of the abovementioned conjugated dienes (2.1) together or by copolymerization of one or more abovementioned unsaturated monomers (2.2), (2.3) and/or (2.4);
(5) ternary copolymers obtained by copolymerization of ethylene, an α-olefin containing from 3 to 6 carbon atoms with an unconjugated diene monomer containing from 6 to 12 carbon atoms;
(6) natural rubber and epoxidized natural rubber;
(7) copolymers obtained by copolymerization of isobutene and isoprene, and the halogenated versions of these copolymers;
(8) functionalized polymers associated with the abovementioned polymers; and
(9) a mixture of at least two of the abovementioned elastomers (1) to (8).

23. The composition as claimed in claim 22, wherein said elastomer composition comprises at least one elastomer selected from:
(1) homopolymeric synthetic polyisoprenes;
(2) copolymeric synthetic polyisoprenes consisting of poly(isoprene-butadiene), poly(isoprene-styrene) and poly(isoprene-butadiene-styrene);
(3) homopolymeric synthetic polydienes consisting of polybutadiene and polychloroprene;
(4) poly(butadiene-styrene);
(5) ethylene-propylene-diene (EPDM) ternary copolymers;
(6) natural rubber and epoxidized natural rubber;
(7) butyl rubber;
(8) functionalized polymers associated with the abovementioned polymers; and
(9) a mixture of at least two of the abovementioned elastomers (1) to (8).

24. The composition as claimed in claim 22, wherein said elastomer composition comprises at least one elastomer selected from: polyisoprene, poly(isoprene-butadiene), poly(isoprene-styrene), poly(isoprene-butadiene-styrene), polybutadiene, poly(butadiene-styrene), ethylene-propylene-diene ternary copolymers, natural rubber and epoxidized natural rubber, and the associated functionalized polymers thereof.

25. The composition as claimed in claim 4, wherein said elastomer composition comprises, as elastomer, at least a mixture of poly(butadiene-styrene) and polybutadiene.

26. The composition as claimed in claim 4, wherein said elastomer composition comprises, as elastomer, at least a mixture of poly(butadiene-styrene) and natural rubber.

27. The composition as claimed in claim 4, wherein said elastomer composition comprises, as elastomer, at least natural rubber.

28. A process for preparing an elastomer composition as claimed in claim 4, said process comprising mixing at least one elastomer, a precipitated silica and at least one polycarboxylic acid, wherein the polycarboxylic acid and precipitated silica are mixed into the elastomer independently of each other.

29. An article comprising at least one composition as claimed in claim 4, wherein the article is at least one article selected from a shoe sole, a floorcovering, a gas barrier, a fire-retardant material, a cable car roller, a seal for household electrical appliances, a seal for liquid or gas pipes, a brake system seal, a pipe, a sheathing, a cable, an engine support, a battery separator, a conveyor belt, a transmission belt and a tire.

30. A tire comprising at least one composition as claimed in claim 4.
